(19) United States
(12) Patent Application Publication
(10) Pub. No.: US 2023/0414028 A1
(43) Pub. Date: Dec. 28, 2023

(54) FRUIT SLITTING DEVICE

(71) Applicant: Fenglin WANG, Shijiazhuang (CN)

(72) Inventor: Fenglin WANG, Shijiazhuang (CN)

(21) Appl. No.: 17/898,253

(22) Filed: Aug. 29, 2022

(30) Foreign Application Priority Data
Jun. 23, 2022 (CN) 2022215829510

(51) Int. Cl. A47J 17/04; A47J 17/16

(52) U.S. Cl. CPC A47J 17/04; A47J 17/16

(57) ABSTRACT

A fruit slitting device is provided and includes a body; a hand connected to an inner side of the body; a blade sleeving ring disposed on an end of the body far away from the handle; slitting blades connected to an inner side of the blade sleeving ring in a snap-fit manner; a barrier plate connected to the inner side of the body, and a fixed block connected to the inner side of the body; columnar springs symmetrically connected to the inner side of the body; and a stretching frame connected to the inner side of the body. The fruit slitting device fully meets needs of slitting operation of small-sized fruits, achieving manual intervention on a position of fruits and effective fruit slitting, which greatly enhances quality of fruit slitting.

### TECHNICAL FIELD

The disclosure relates to a technical field of slitting fruits, and more particularly to a fruit slitting device.

### BACKGROUND

In daily life, people are pursuing a more delicate diet of fruits and vegetables than ever before. With an increasing miniaturization of various fruits, such as hot sales of small oranges, small melons and cherry tomatoes, slitting these fruits also becomes an essential operation. Due to the miniaturization of these fruits, the slitting operation needs to be very careful. Because of arc-shaped fruit surface, it is difficult to apply force by hand to normal knives while slitting, there is also a high risk of injury to hands. In addition, a speed of slitting is also slow, which cannot achieve efficient operation. And common slitting devices in current market also have limitations, so there is a huge room for improvement and innovation.

Although there are many categories of fruit slitting devices in the market, there are common problems such as trouble in splitting to clean, trouble in cleaning slitting blades, poor applicability for different fruit sizes, trouble in slitting evenly, difficulty in getting effective slitting effect (easy to get stuck in slitting chamber), inability to visualize and manually adjust position of fruits while slitting.

### SUMMARY

The disclosure aims to provide a fruit slitting device, so as to solve problems proposed in the above background that although there are many categories of fruit slitting devices in current market, there still has trouble in splitting to clean, trouble in cleaning slitting blades, poor applicability for different fruit sizes, trouble in slitting evenly, difficulty in getting effective slitting effect (easy to get stuck in slitting chamber), inability to visualize and manually adjust position of fruits while slitting and other common problems.

In order to achieve the above purposes, the disclosure provides a technical solution as follows.

An embodiment of the disclosure provides a fruit slitting device, including a body, a handle connected to an inner side of the body, a blade sleeving ring disposed on an end of the body far away from the handle, slitting blades horizontally connected to an inner side of the blade sleeving ring in a snap-fit manner, a barrier plate connected to the inner side of the body, a fixed block connected to the inner side of the body, columnar springs symmetrically connected to the inner side of the body and a stretching frame horizontally connected to the inner side of the body in a snap-fit manner.

In an illustrated embodiment, a shape of the body is cylindrical, a bottom of the body is provided with a structure of semi-profile, and the inner side of the body is provided with symmetrically arranged guiding grooves.

In an illustrated embodiment, two ends of the handle extend through openings of two sides of the body to an outer side of the body. A side of the handle is disposed on a screw hole provided on an end of the stretching frame. And the side of the handle is fixed on the end of the stretching frame by a bolt through the screw hole.

In an illustrated embodiment, an opening end of the stretching frame far away from the handle is provided with a snap-in groove and the blade sleeving ring is snapped into the snap-in groove. The slitting blades are two flat slitting blades, each of which is provided with a notch in a middle position. The slitting blades are lapped in a cross shape through the notches, and connected to the inner side of the blade sleeving ring. The blade sleeving ring is provided with grooves, and ends of the slitting blades are snapped into the grooves respectively.

In an illustrated embodiment, a side of the barrier plate is provided with a concave structure and the concave structure is provided with a concave surface facing towards the slitting blades. A side of the barrier plate far away from the concave surface is connected to a side of the fixed block, and the barrier plate is fixedly connected to the fixed block through columns and snap-in holes. The fixed block is connected to the inner side of the body far away from an opening end of the body. A side of the fixed block is provided with a rectangular notch, and a crossbar of the stretching frame is snapped into the rectangular notch.

In an illustrated embodiment, two sides of the stretching frame are provided with guiding bars respectively, and the guiding bars are disposed in guiding grooves of the body respectively. The number of the columnar springs is two, and the two columnar springs are connected to inner sides of the guiding grooves of the body correspondingly, and the columnar springs are sleeved on columns disposed on ends of the guiding bars respectively.

An embodiment of the disclosure provides a fruit slitting device, including a body, which is provided with an opening and guiding grooves disposed two sides of the opening respectively, columnar springs disposed in the guiding grooves respectively, a stretching frame provided with a crossbar and guiding bars fixedly connected to the crossbar and a side of the crossbar far away from the guiding bars provided with columns sleeved with the columnar springs, a blade sleeving ring detachably connected to ends of the guiding bars far away from the crossbar, slitting blades detachably connected to the blade sleeving ring and located on the ends of the guiding bars far away from the crossbar, a barrier plate provided with notches matching with the guiding bars and disposed between the crossbar and a position of the slitting blades, a handle extending through the opening by two ends and which is movable relative to the body, and a fixed block detachably connected to the barrier plate by a side and detachably connected to the handle through the crossbar by another side opposite to the side.

Compared with the related art, the disclosure has effective effect as follows:
the disclosure makes an all-round innovative design, such as design of splitting to clean, design of splitting of slitting blades, design of arc-shaped structure, design of double guiding to locating the slitting blades, design of through-hole slitting, and design of semi-profile visual slitting chamber with intervention of fruit position, which bases on low cost and good quality to fully meet needs of slitting operation of small-sized fruits. Firstly, using a structural assembly by interference pressing, which is easier to disassemble and clean. The slitting blades use independent and flat blades with notch in middle position, and are assembled through the notches in cross shape, which can make the slitting blades recover a flat status after disassembling and easy to clean. The slitting blades are assembled into a cross shape, which is easy to slit. The barrier plate is designed with a concave surface. Therefore, arc-shaped fruits will slide into a center of the barrier plate automatically, which makes the fruits occupied a middle position of the slitting blades. Different sizes of the fruits are easy to occupy the middle position and divided evenly. As the body is provided with a through-hole end as a fruit exit, the slitting fruits eventually slide into a back end of the stretching frame, then slide into the cylindrical exit end of the body, which allows the slitting fruits to slide out. The slitting chamber of the body is provided with an opening end, which makes it clear to put, squeeze and slit. In addition, the whole process achieves manual intervention of fruits position and greatly improves slitting quality.

### BRIEF DESCRIPTION OF DRAWINGS

Other features, purposes and advantages of the disclosure will be more apparent by reading and referring to the attached drawings, which describe the no-limiting embodiments in detail.

FIG. 1 is a three-dimensional schematic diagram of a fruit slitting device according to an embodiment of the disclosure.

FIG. 2 is a schematic diagram of splitting connection details of the fruit slitting device according to an embodiment of the disclosure.

FIG. 3 is a schematic diagram of body connection details of the fruit slitting device according to an embodiment of the disclosure.

FIG. 4 is a schematic diagram of slitting blades connection details of the fruit slitting device according to an embodiment of the disclosure.

FIG. 5A and FIG. 5B are schematic diagrams of barrier plate connection details of the fruit slitting device according to an embodiment of the disclosure.

FIG. 6A and FIG. 6B are schematic diagrams of stretching frame connection details of the fruit slitting device according to an embodiment of the disclosure.

FIG. 7A and FIG. 7B are schematic diagrams of fixed block connection details of the fruit slitting device according to an embodiment of the disclosure.

### DESCRIPTION OF REFERENCE NUMERALS

1-body; 2-handle; 3-blade sleeving ring; 4-slitting blade; 5-barrier plate; 6-fixed block; 7-columnar spring; 8-stretching frame.

### DETAILED DESCRIPTION OF EMBODIMENTS

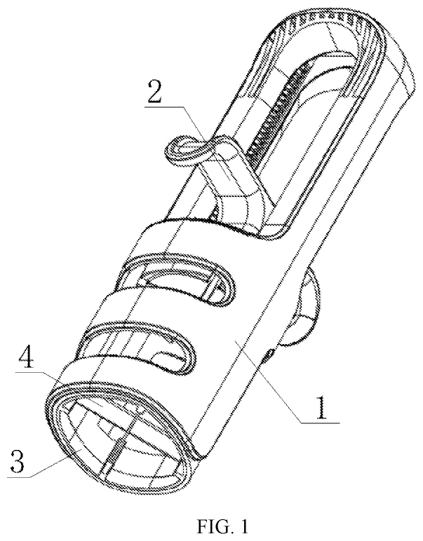

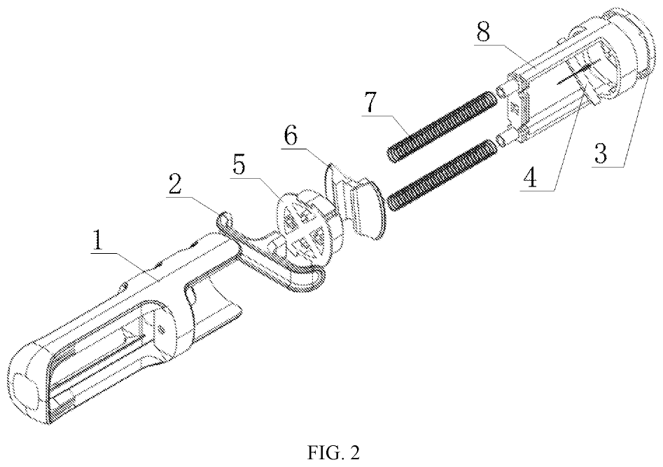

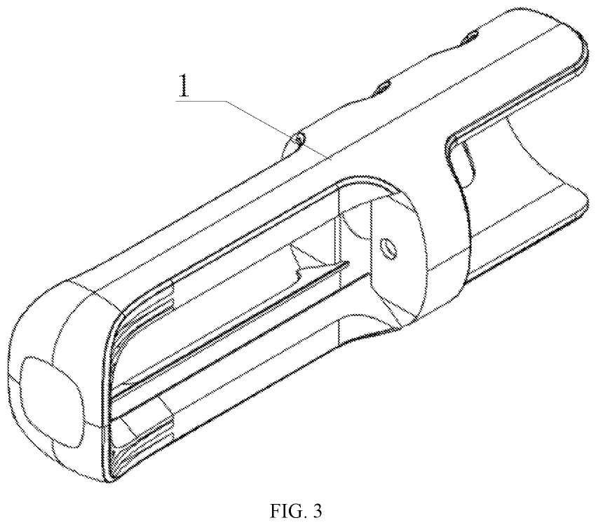

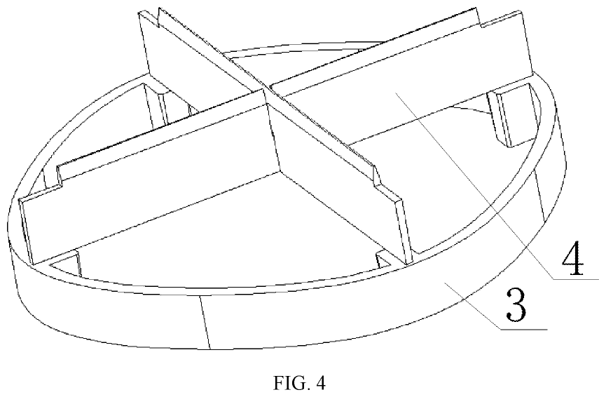

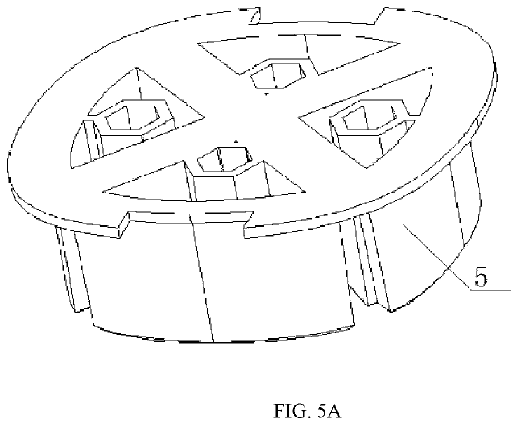

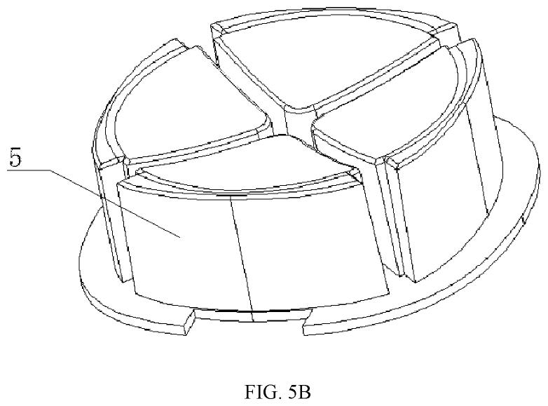

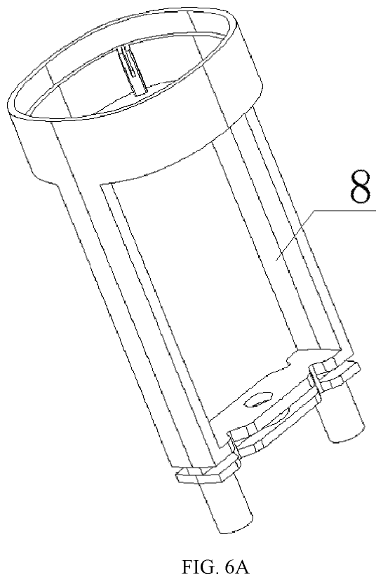

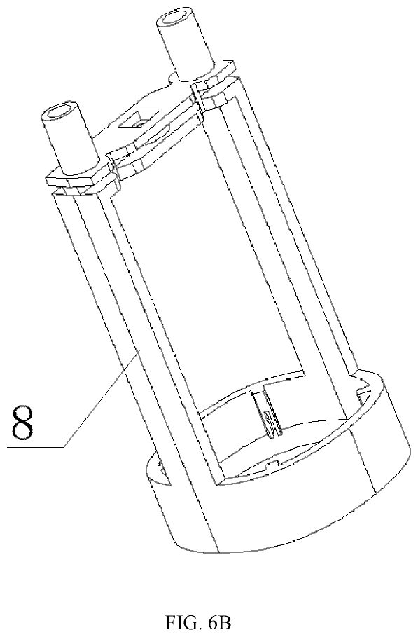

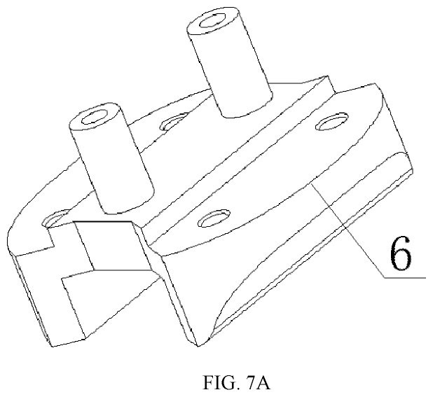

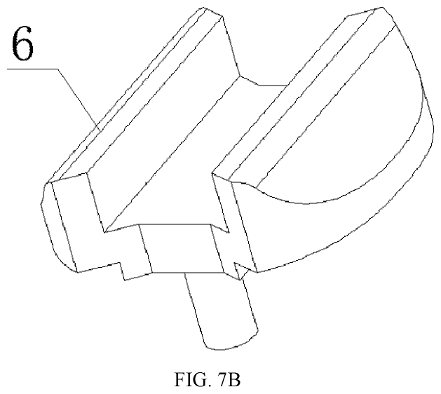

Reference to FIG. 1 to FIG. 7B, the disclosure is provided with a fruit slitting device, including a body 1 connected with a handle 2 in an inner side of the body 1. A shape of the body 1 is cylindrical and a bottom of the body 1 is provided with a structure of semi-profile and the inner side of the body is provided with symmetrically arranged guiding grooves. Two ends of the handle 2 extend through openings of two sides of the body 1 to an outer side of the body 1 and a side of the handle 2 is set on a screw hole disposed on an end of a stretching frame 8, and the side of the handle 2 is fixed on the end of the stretching frame 8 by a bolt through the screw hole. A blade sleeving ring 3 is provided on an end of the body 1 far away from the handle 2. Slitting blades 4 are horizontally connected to an inner side of the blade sleeving ring 3 in a snap-fit manner. An opening end of the stretching frame 8 far away from the handle is provided with a snap-in groove, and the blade sleeving ring 3 is snapped into the snap-in groove. The slitting blades 4 are two flat slitting blades, each of which is provided with a notch in a middle position, are lapped in a cross shape through the notches, and are connected to the inner side of the blade sleeving ring 3. The blade sleeving ring 3 is provided with grooves, and ends of the slitting blades 4 are snapped into the grooves respectively. A barrier plate 5 is connected to the inner side of the body 1. The barrier plate 5 is a cylindrical structure in line with the opening end of the stretching frame 8. One side of the barrier plate 5 that is provided with a same diameter as the opening end of the stretching frame 8 is seen as a small end side. Another side of the barrier plate 5 that is provided with a larger outer diameter is provided with a step structure, which is seen as a large end side. The large end side is provide with rectangular notches, which fit into guiding bars of the stretching frame 8 to ensure a normal axial sliding of the guiding bars of the stretching frame 8. In addition, the large end side also fits into step grooves in a middle annular part of the body 1. Therefore, the body 1 has a limiting effect on the barrier plate 5. The small end side is provided with a concave structure, including a concave surface. The concave surface is also designed with notches, which are matched with the slitting blades 4 on the stretching frame 8, so as to ensure that fruits are completely cut during a movement of the stretching frame 8 and the slitting blades 4 normally move. A fixed block is connected to the inner side of the body 1. The concave surface of the barrier plate 5 is facing towards the slitting blades 4. The large end side of the barrier plate 5 is fixed on a side of the fixed block 6. The barrier plate 5 is fixedly connected to the fixed block 6 through columns and snap-in holes. The fixed block 6 is connected to the inner side of the body 1 far away from an opening end of the body 1, and a side of the fixed block 6 is provided with a rectangular notch. A crossbar of the stretching frame 8 is snapped into the rectangular notch. The fixed block 6 is a limiting location block, and is assembled between the handle 2 and the barrier plate 5, and is indirectly assembled with the stretching frame 8 by interference pressing. After assembly, the fixed block 6 and the body 1 are limited in a radical direction. Therefore, the body 1 cannot rotate freely. Additionally, the fixed block 6 is also connected with the handle 2 and the stretching frame 8, so that when the handle 2 is under an external force of hand, the handle will make an axial reciprocating movement together with the fixed block 6 and the stretching frame 8 to achieve the fruit slitting. Columnar springs 7 are symmetrically connected to the inner side of the body 1 and a stretching frame 8 is horizontally connected to the inner side of the body 1. The number of the columnar springs 7 is two. The two columnar springs 7 are connected to inner sides of guiding grooves of the body 1 correspondingly. Two sides of the stretching frame 8 are provided with guiding bars respectively, and the columnar springs are sleeved on columns disposed on outer ends of the guiding bars. And the guiding bars are disposed in the guiding grooves of the body 1 respectively. Cylindrical end of the stretching frame 8 is the opening end of the stretching frame 8 that installs the slitting blades 4. The two guiding bars extend in radially symmetrical orientation at the cylindrical end. Each of the two guiding bars protrudes a column and the column can be inserted into a cavity of the columnar springs 7, which can ensure stability of force point of the stretching frame 8 during compression and extension of the columnar springs 7. The two columns disposed on the top of the guiding bars of the stretching frame 8 are also connected with a one-piece molded plastic structure and the crossbar of the stretching frame 8 is provided with the square screw hole in a middle position, which is used for press-fit assembly of the stretching frame 8 with the fixed block 6 and the handle 2. The guiding bars of the stretching frame 8 is aligned with the notches on the barrier plate 5, so that the barrier plate 5 and the stretching frame 8 can maintain a relative column surface stability when a relative axial sliding happens between the barrier plate 5 and the stretching frame 8.

Components are in line with common standard or known to those skilled in the art. Structure and principles are known to those skilled in the art through technical manuals or by conventional experiments.

Working principles of the disclosure are as follows:

The slitting blades 4 are provided with two blades, each of which is provided with a notch in middle position. The two blades are crimped together through the notch to form a cross shape (disassemble). The crimped slitting blades 4 are installed in grooves on an opening end of the stretching frame 8, and then the blade sleeving ring 3 is pressed into the stretching frame 8 with interference, so as to realize an integrative assembly of the stretching frame 8 with the slitting blades 4. The barrier plate 5 is sleeved on the stretching frame 8 with a concave surface of the barrier plate 5 facing towards the stretching frame 8. The two columnar springs 7 are inserted into the guiding grooves of the body 1 respectively. The fixed block 6 is installed in a blank area at the top of the body 1, and the handle 2 is installed at top of the fixed block 6. The initially integrative assembly of the stretching frame 8 is inserted into an end with a cylindrical side of the body 1. Then, two columns disposed on the stretching frame 8 are inserted into the columnar springs 7 disposed in the guiding grooves of the body 1. At the same time, the handle 2 is assembled with the fixed block 6 by interference pressing to form an assembly. Then, the assembly is connected to the stretching frame 8 by interference pressing. Therefore, using a thumb to press the top of the body and an index finger and a middle finger to hook on the handle, and pressing together, the handle 2 will drive the stretching frame 8 to squeeze the two columnar springs 7 to compress the relative distance between the barrier plate 5 and the slitting blades 4, which can realize a cross slitting to make the fruits set in the device evenly divided into four. The divided fruits can smoothly slide out through the columnar end of the body 1, which means a complete fruit slitting. After that, the thumb, the index finger and the middle finger relaxes, so the stretching frame 8 will recover to the initial status under the extension force of the columnar springs 7, which finishes a complete fruit slitting process. A next fruit slitting process will start when another fruit is put between the barrier plate 5 and the slitting blades 4.

The above description is only the exemplary embodiment of the disclosure, but the protection scope of the disclosure is not limited to this. Any equivalent replacement and change according to the technical solutions of the disclosure or the idea of the disclosure made by those skilled in the related art within the technical scope of the disclosure shall be covered in the protection scope of the disclosure.

What is claimed is:

1. A fruit slitting device, comprising:
a body;
a handle, connected to an inner side of the body;
a blade sleeving ring, disposed on an end of the body far away from the handle;
slitting blades, horizontally connected to an inner side of the blade sleeving ring in a snap-fit manner;
a barrier plate, connected to the inner side of the body;
a fixed block, connected to the inner side of the body;
columnar springs, symmetrically connected to the inner side of the body; and
a stretching frame, horizontally connected to the inner side of the body.

2. The fruit slitting device according to claim 1, wherein a shape of the body is cylindrical, a bottom of the body is provided with a structure of semi-profile, and the inner side of the body is provided with symmetrically arranged guiding grooves.

3. The fruit slitting device according to claim 1, wherein two ends of the handle extend through openings of two sides of the body to an outer side of the body; and
wherein a side of the handle is disposed on a screw hole disposed on an end of the stretching frame, and the side of the handle is fixed on the end of the stretching frame by a bolt through the screw hole.

4. The fruit slitting device according to claim 1, wherein an opening end of the stretching frame far away from the handle is provided with a snap-in groove, and the blade sleeving ring is snapped into the snap-in groove;
wherein the slitting blades are two flat slitting blades, each of the slitting blades is provided with a notch in a middle position, the slitting blades are lapped in a cross shape through the notches and connected to the inner side of the blade sleeving ring; and
wherein the blade sleeving ring is provided with grooves, and ends of the slitting blades are snapped into the grooves respectively.

5. The fruit slitting device according to claim 1, wherein a side of the barrier plate is provided with a concave structure and the concave structure is provided with a concave surface facing towards the slitting blades;
wherein a side of the barrier plate far away from the concave surface is connected to a side of the fixed block, and the barrier plate is fixedly connected to the fixed block through columns and snap-in holes;
wherein the fixed block is connected to the inner side of the body far away from an opening end of the body, a side of the fixed block is provided with a rectangular notch, and a crossbar of the stretching frame is snapped into the rectangular notch.

6. The fruit slitting device according to claim 1, wherein two sides of the stretching frame are provided with guiding bars respectively, and the guiding bars are disposed in guiding grooves of the body respectively; and
wherein the number of the columnar springs is two, the two columnar springs are connected to inner sides of the guiding grooves of the body correspondingly, and the columnar springs are sleeved on columns disposed on ends of the guiding bars respectively.

7. A fruit slitting device, comprising:
a body, wherein the body is provided with an opening and guiding grooves disposed in two sides of the opening respectively;
columnar springs, disposed in the guiding grooves respectively;
a stretching frame, wherein the stretching frame is provided with a crossbar and guiding bars fixedly connected to the crossbar, a side of the crossbar far away from the guiding bars is provided with columns sleeved with the columnar springs;
a blade sleeving ring, detachably connected to ends of the guiding bars far away from the crossbar;
slitting blades, detachably connected to the blade sleeving ring and located on the ends of the guiding bars far away from the crossbar;
a barrier plate, provided with notches matching with the guiding bars and disposed between the crossbar and a position of the slitting blades;
a handle, wherein two ends of the handle extend through the opening, and the handle is movable relative to the body; and
a fixed block, wherein a side of the fixed block is detachably connected to the barrier plate, and another side opposite to the side of the fixed block is detachably connected to the handle through the crossbar.
